(19) United States
(12) Patent Application Publication
(10) Pub. No.: US 2015/0353017 A1
(43) Pub. Date: Dec. 10, 2015

(54) VEHICLE MIRROR AND REAR-FACING DEVICES AND METHOD OF REDUCING DRAG

(71) Applicant: Malcolm Freeman, Georgetown (CA)

(72) Inventor: Malcolm Freeman, Georgetown (CA)

(21) Appl. No.: 14/735,059

(22) Filed: Jun. 9, 2015

Related U.S. Application Data
(60) Provisional application No. 62/009,895, filed on Jun. 9, 2014.

(51) Int. Cl. B60R 1/06

(52) U.S. Cl. CPC B60R 1/06

(57) ABSTRACT

A method for reducing drag upon land, sea and air based vehicles by applying a tail to the mirror, mirror housing, or rearward-viewing device housing which results in a decrease in drag of the rear-facing mirrors, mirror housings, or rear-ward viewing device, and in total, vehicle drag. In one embodiment, where the material used for the tail passes between an intended observer of the mirror and the mirror itself, or between the rearward-viewing device and objects within its field of view, the material is clear or substantially transparent.

### CROSS-REFERENCE TO RELATED APPLICATION

This application claims priority under 37 CFR 35 U.S.C. §120 to U.S. Provisional Patent Application Ser. No. 62/009,895 filed on Jun. 9, 2014, the contents of which are incorporated herein by reference.

### FIELD OF THE INVENTION

The following relates to methods and devices for reducing drag on rearward facing mirrors, their mirror housings or rearward viewing devices and their housings.

### BACKGROUND OF THE INVENTION

Current proposed shapes for rearward-facing mirrors or rearward-facing devices address the leading edge of the housing to reduce aerodynamic or hydrodynamic drag. As a result these shapes do not address the drag created by the space of the mirror or mirror housing or rearward-facing device's reflective surface of a mirror or rearward-facing device's field of view.

There have been previous attempts to generally address the issue of drag created by mirrors and mirror housings, but the inventor is aware of no previous solutions for rearward-viewing devices or for forward- or rearward-viewing hydrodynamic viewing devices.

What each of these prior art approaches has in common is they are addressing the aerodynamic drag created by a mirror by creating a leading edge fairing to house the mirror or rearward-viewing device. However, none of these approaches address the drag created in the aft section of a mirror or mirror housing or rearward-facing device.

### SUMMARY OF THE INVENTION

To the knowledge of the inventor, there are no prior design approaches directed to reducing drag on forward- or rearward-viewing devices. However, the inventor has identified an opportunity to address the drag created by a mirror, mirror housing, rearward- or forward-viewing device by addressing the aft section of a mirror, mirror housing, rearward- or forward-viewing device. The configurations provided herein are effective at reducing the drag of a mirror, mirror housing, rearward- or forward-viewing device applicable to all vehicles, and are straightforward to implement.

The unique configuration provided herein addresses the drag created in the aft section of the mirror, mirror housing, rearward- or forward-viewing device by providing one or more surfaces of equal or unequal length in a closed or open configuration in the aft section for the flow to pass along thereby reducing the drag of the mirror, mirror housing, rearward or forward viewing device. Where the surfaces are positioned to pass between the intended observer of the mirror (such as the driver of the vehicle) and the mirror itself, and/or to pass between objects intended to be viewed by the observer via reflection in the mirror (objects to be appearing in the mirror to the observer, such as vehicles behind the vehicle with the subject mirror), the surfaces are at least partly constructed of a material that can be seen through, such as plexi-glass or other transparent or nearly-transparent material. By providing a transparent or nearly-transparent material for producing the drag reducing structures, drag reduction can be provided without a problematic impact on visibility provided by the mirror.

Known types of drag reduction methods can be used in conjunction with the invention disclosed herein to reduce the overall drag of the mirror, mirror housing, rearward or forward viewing device.

The general purpose of the present invention, which will be described subsequently in greater detail, is to provide a new drag reduction configuration which has many novel features that result in a reduction of drag which is not anticipated, rendered obvious, suggested or even implied by any of the prior design methods known to the inventor, either alone or in combination thereof.

The invention discussed in this document offers a means to reduce the drag of a rearward- facing mirror, mirror housing, rearward- or forward-viewing devices. The method includes reducing the drag of a mirror, mirror housing, rearward- or forward-viewing devices by adding an extension aft of the mirror, mirror housing, rearward- or forward-viewing device by providing one or more aerodynamic or hydrodynamic surfaces for the flow to travel along and thereby reduce the drag aft the mirror, mirror housing, or rearward- or forward-viewing device.

In accordance with an aspect there is provided a method for reducing the drag of a vehicle having a rearward-facing mirror or rearward- or forward- viewing device by increasing the length such device's housing with a trailing edge consisting of a closed housing in clear material that forms an aerodynamic tail, thereby significantly reducing the aerodynamic drag of said devices.

In accordance with another aspect there is provided an external mirror system for a vehicle comprising a mirror housing supporting a rearward-facing mirror having an exterior surface forming a leading edge forward of the mirror; and a transparent enclosure aligned with and extending continuously rearward with respect to the mirror from the exterior surface of the mirror housing to a substantially-narrowed trailing edge, and wherein the mirror is viewable through the transparent enclosure from within the vehicle.

In accordance with another aspect there is provided an external mirror system for a vehicle comprising a mirror housing supporting a rearward-facing mirror having a continuous exterior surface forming a leading edge forward of the mirror and a substantially narrowed trailing edge rearward of the mirror, wherein at least a portion of the mirror housing is transparent in order to permit viewing the mirror from within the vehicle.

In accordance with another aspect there is provided an external mirror system for a vehicle comprising a mirror housing supporting a rearward-facing mirror having an airfoil shape with a forward- and rearward-edge of the mirror housing with at least a portion of the mirror housing being transparent to permit viewing of the mirror from within the vehicle.

In accordance with another aspect there is provided a method for reducing the drag of a vehicle having a rearward-facing mirror, mirror housing or rearward- or forward-viewing device by increasing the length of a rearward-facing mirror, mirror housing or rearward- or forward-facing device's housing with a trailing edge whereby this extension forms a single-sided extension of the mirror or rearward-viewing device housing where the extension reflected in the mirror surface or rearward-facing device may or may not be clear and extends into the field of view of a mirror or rearward-facing device and this trailing edge forms an aerodynamic or hydrodynamic surface for a rearward-facing mirror or rearward-view device's rear edge, where the flow separated by the leading edge flows along this surface thereby reducing the aerodynamic drag of a mirror or rearward-viewing device.

In accordance with another aspect there is provided a method for reducing the drag of a vehicle having a rearward-facing mirror, mirror housing, rearward- or forward-viewing device by increasing the length of a rearward-facing mirror, mirror housing or rearward- or forward-facing device's housing with two or more trailing edges whereby this extension forms an open ended extension of the mirror, mirror housing or rearward-viewing device housing where the extension reflected in the mirror surface or rearward-facing device may or may not be clear and extends into the field of view of a mirror, rearward or forward-viewing device and these trailing edges form one or more aerodynamic or hydrodynamic surfaces for a rearward-facing mirror, mirror housing, rearward- or forward-viewing device's rear edge(s), where the flow separated by the leading edge follows these surfaces thereby reducing the aerodynamic drag of a mirror, mirror housing, forward- or rearward- viewing device's housing or device.

In accordance with another aspect there is provided an external camera system for a vehicle comprising a camera housing supporting a rearward-facing camera having an exterior surface forming a leading edge forward of the camera; and a transparent enclosure aligned with and extending continuously rearward with respect to the camera from the exterior surface of the mirror housing to a substantially-narrowed trailing edge, and wherein the camera has a field of view looking through the transparent enclosure.

In accordance with another aspect there is provided an external camera system for a vehicle comprising a camera housing supporting a rearward-facing camera having a continuous exterior surface forming a leading edge forward of the camera and a substantially narrowed trailing edge rearward of the camera, wherein at least a portion of the camera housing is transparent in order to permit the camera to have a field of view looking rearward of the vehicle through the transparent portion of the camera housing.

In accordance with another aspect there is provided an external camera system for a vehicle comprising a camera housing supporting a rearward-facing camera having an airfoil shape with a forward- and rearward-edge of the camera housing with at least a portion of the camera housing being transparent to permit the camera to have a field of view looking rearward of the vehicle through the transparent portion.

Other aspects and various advantages are disclosed herein.

### BRIEF DESCRIPTION OF THE DRAWINGS

Embodiments will now be described with reference to the appended drawing in which: each component of the mirror system is labelled with the following numbers corresponding to the part; 1=mirror, 2=mirror housing, 3=mirror tail, 4=vehicle, 5=inside door panel of vehicle, 6=representation of air flow, 7=mounting screws, 8=marker lights, 9=camera lens, 10=camera housing.

FIG. 1 is a side view illustrating horizontal airflow about an un-faired mirror during forward movement;

FIG. 2 is a rear-facing view illustrating horizontal application during forward movement about a mirror that has been faired according to an embodiment;

FIG. 3 is a front view illustrating airflow during forward movement about a mirror that has been faired according to an embodiment;

FIG. 4 is an isometric view illustrating airflow during forward movement about a mirror that has been faired according to an embodiment;

FIG. 5 is a top view illustrating airflow during forward movement about a mirror that has been faired according to an embodiment;

FIG. 6 is an isometric view illustrating airflow during forward movement about a mirror that has been faired according to an alternative embodiment; and

FIG. 7 is a front view of an alternative embodiment showing a side-mounted camera tail application in which a housing houses a rear-viewing camera and a marker light, the rear-viewing camera electronically communicating with a display screen (not shown) for displaying the objects within the field of view of the rear-viewing camera.

### DETAILED DESCRIPTION

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the invention.

Drag analysis of existing mirrors, mirror housings or rearward-facing devices as demonstrated in this video on a wind-tunnel dynamometer and therein represented by a disk, measures the amount of drag as measured on the wind-tunnel dynamometer at 05:09 minutes in this video https://www.youtube.com/watch?v=4q5ffroIMMc This particular segment clearly illustrates the measured drag of a mirror housing lacking a mirror tail by not addressing the aft section of the mirror. The overall drag of the mirror (represented by the disk) with a leading edge cowling and aft section tail further measures the overall drag reduction of the mirror tail as represented by the streamlined attachment to the wind tunnel dynamometer thereby demonstrating the aerodynamic efficiency achieved by a tail being applied to a surface that is perpendicular to air flow as demonstrated in the video at 05:27 minutes. Calculations in this video show a potential for drag reductions of a tail fairing to be 50-55% compared to a leading edge fairing alone. These aerodynamic test results corroborate the base drag reduction of a tail fairing applied to a surface that is perpendicular to air flow over a flat surface with a leading-edge fairing. This result is extremely important because it demonstrates that the addition of a tail section greatly reduces drag and improves efficiency of a mirror, mirror housing, rearward- or forward-viewing device compared to a such a with only a leading-edge fairing. This result improves the overall aerodynamic efficiency of an un-faired surface perpendicular to the air flow by 95% compared to an un-faired surface, as demonstrated at 05:50 minutes in this video.

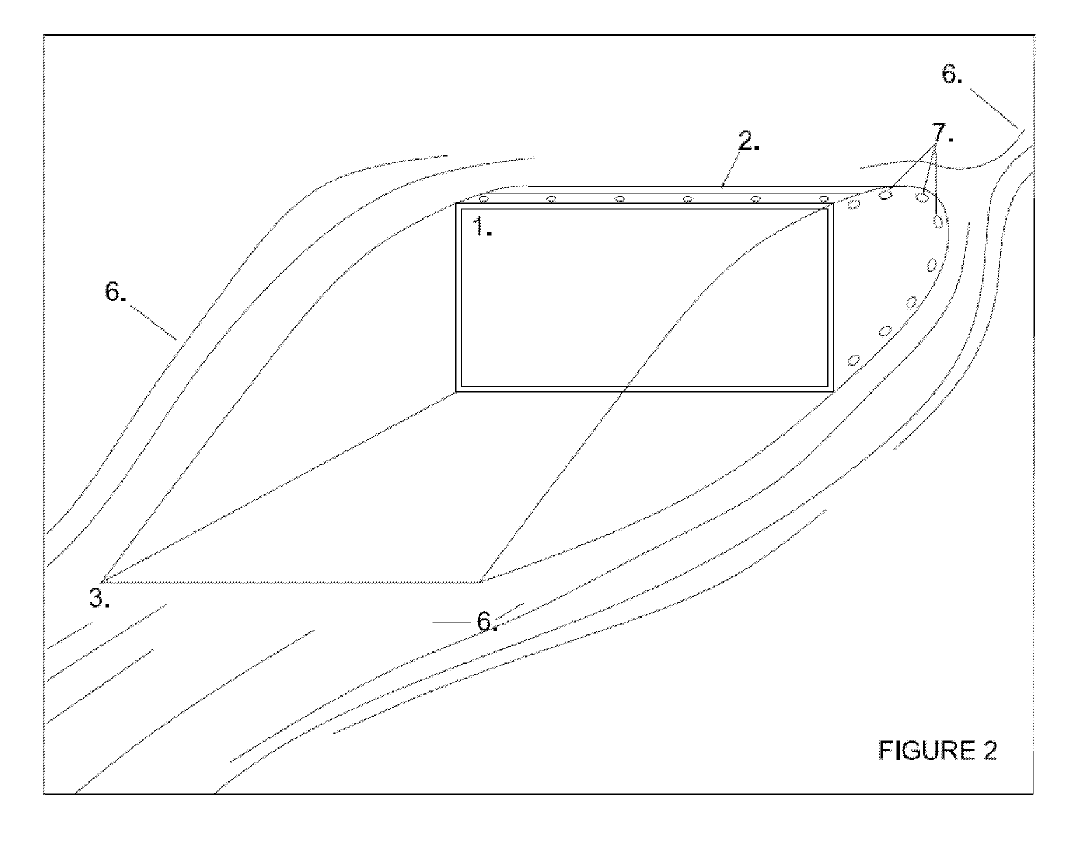

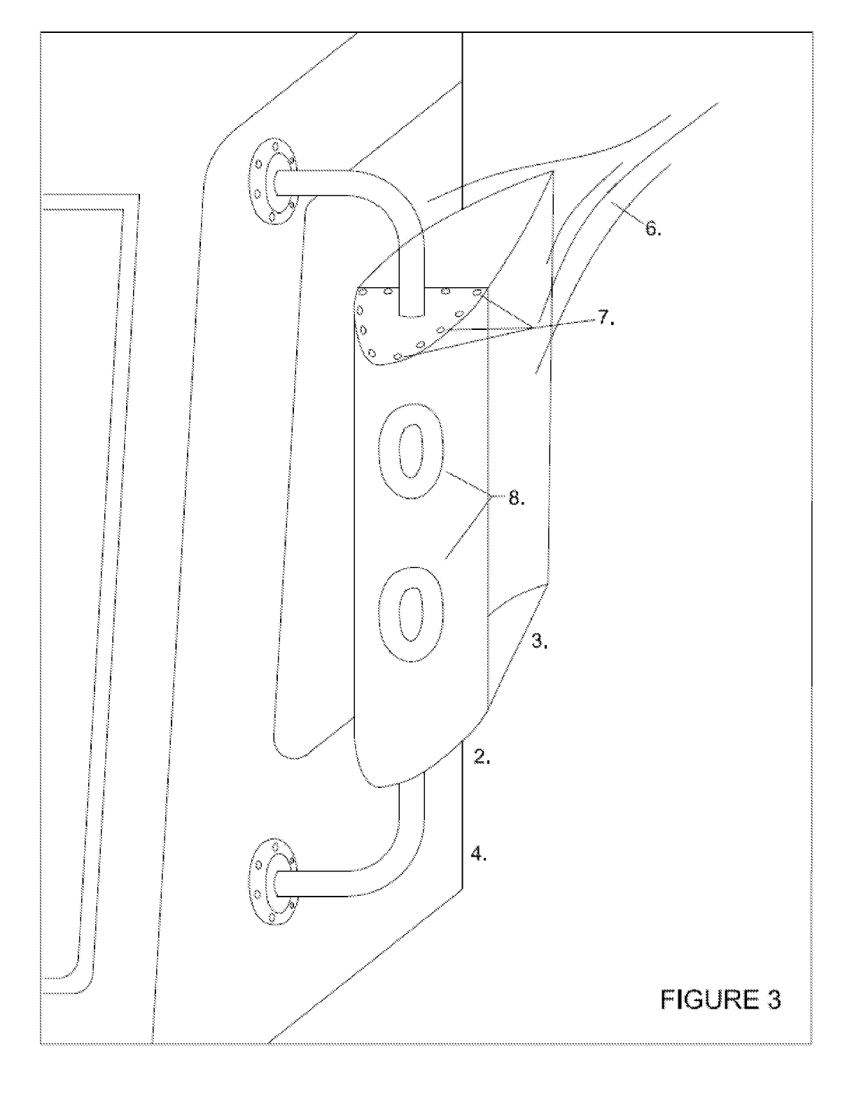

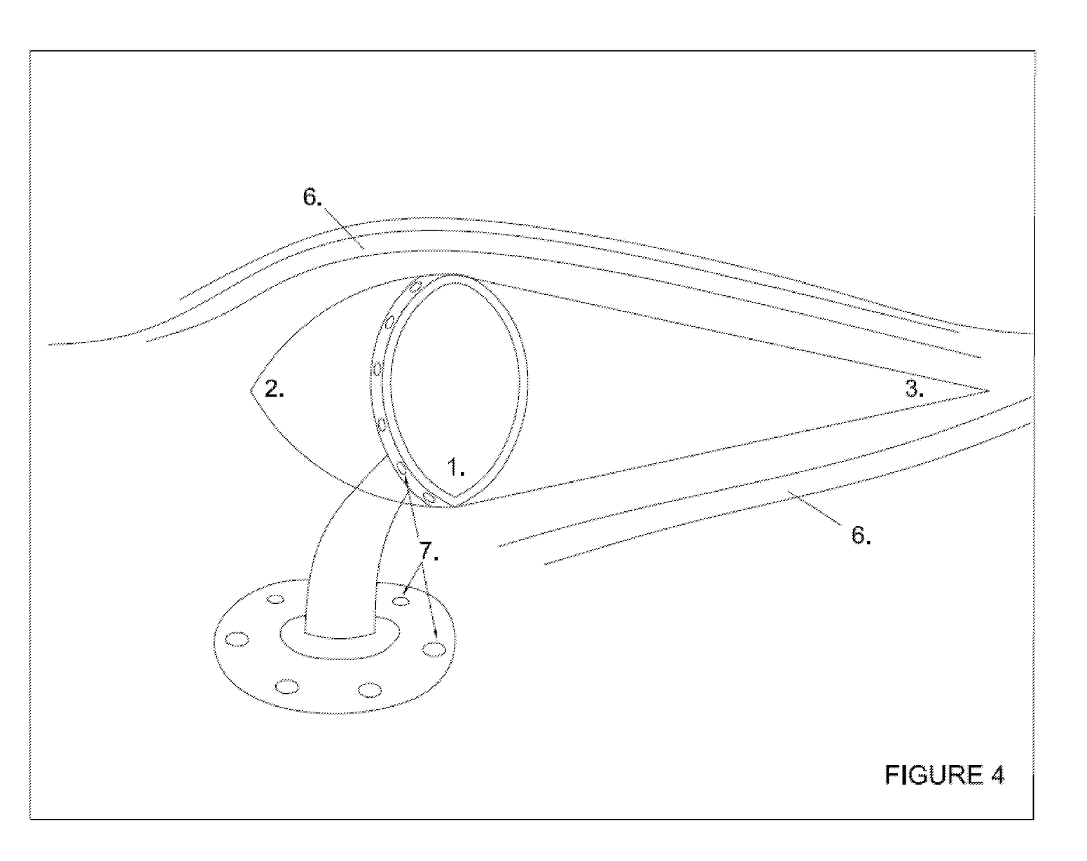

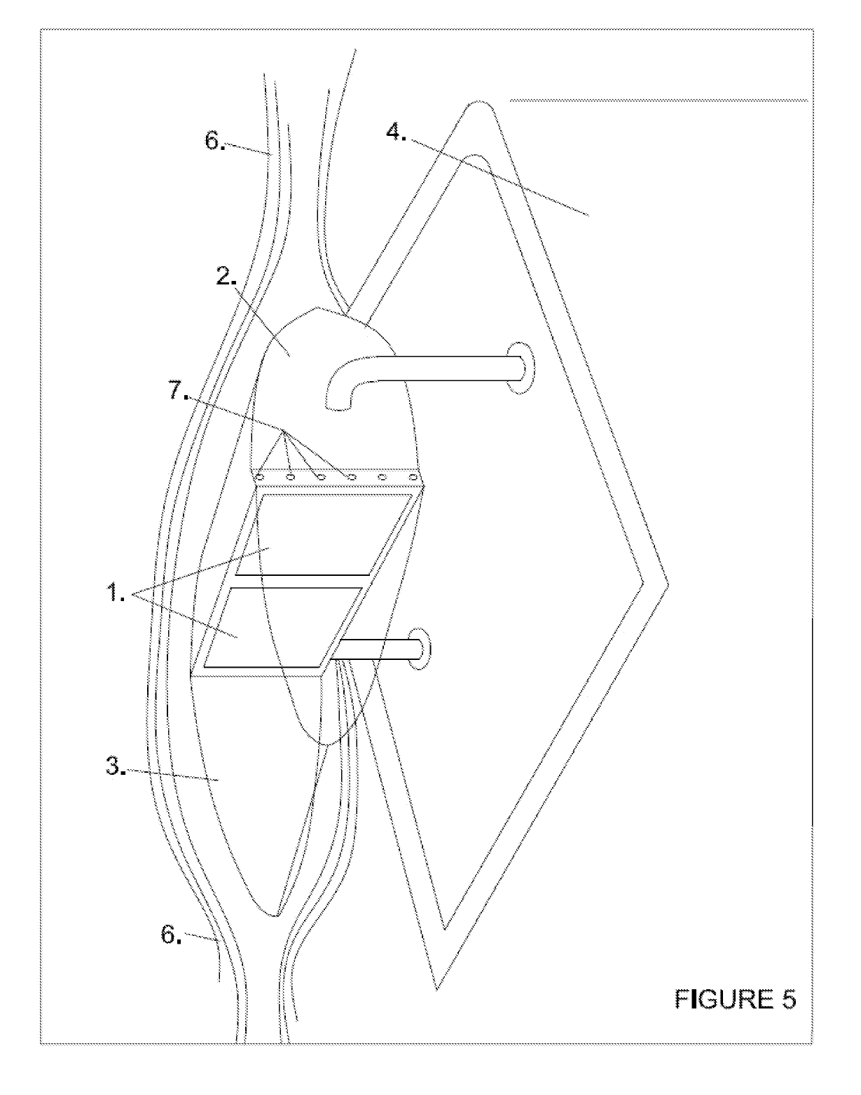

For rearward facing mirrors whose surface is generally perpendicular to the air flow are (represented in this video at 04:57 minutes) a tail fairing or wing greatly reduces aerodynamic drag (shown in the video at 05:27 seconds). The trend is presented in FIGS. 2, 3, 4, 5, 6 which show that overall drag reduction achieved by applying a tail fairing to a flat or leading-edge surface.

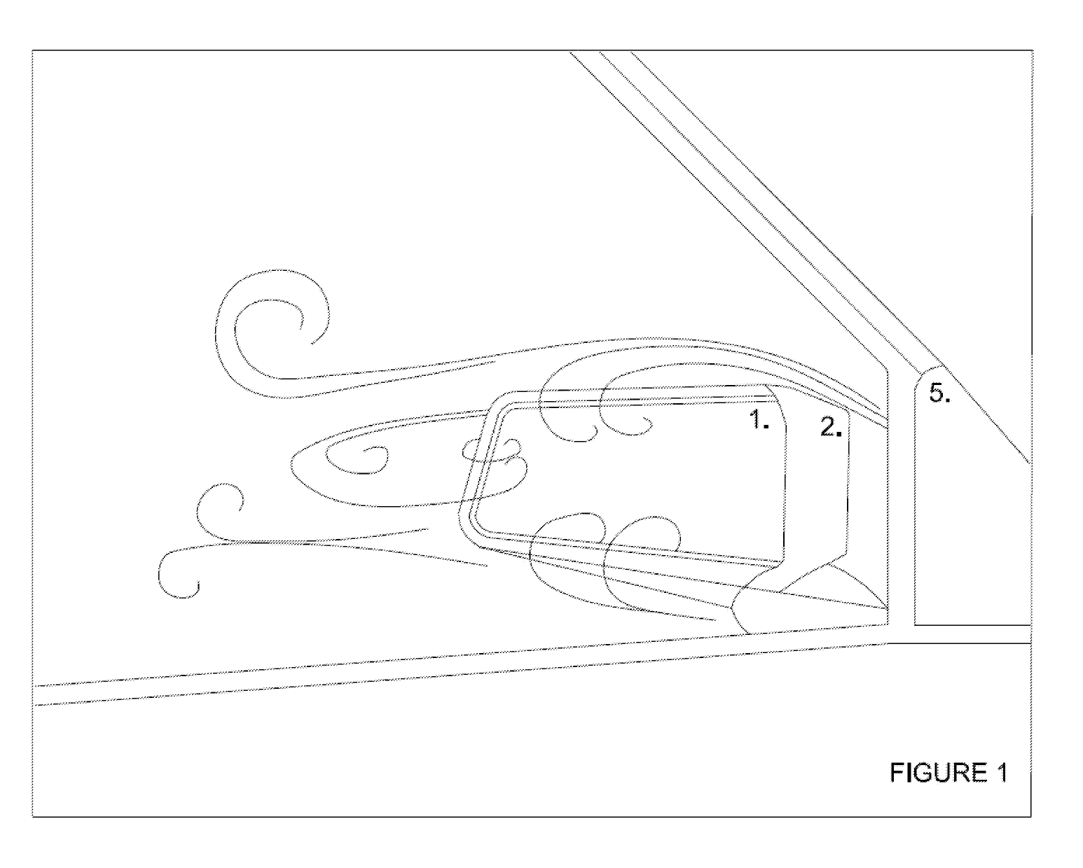

This drag reduction is a result of reducing the vortices created by a surface that is perpendicular to the flow even if the leading edge of said surface is faired with a trailing edge. The vortices created by the difference in pressure by the lack of tail fairing are caused by the air vacating the area of relatively high pressure created behind the mirror as a result of the relatively low pressure created by the flow past this still air or fluid and this perpendicular motion of the air shedding swirling vortices increasing aerodynamic drag. This shedding of vortices at first appears random, but in reality the outward motion of the air on the opposite side of the incoming air creates a wave or wake that is repeated on the other side when the air pressure on the exiting air becomes equal to the surrounding air thus creating an area of low pressure on the other side; this repetitive vortex shedding on opposite sides of the perpendicular surface creates a oscillating wave that results in drag. This vortex shedding and repetitive wave is graphically illustrated in FIG. 1. This vortex shedding and resulting wave is because the high-speed external flow “pulls” air out of the still air trapped behind the surface perpendicular to the flow according to Bernoulli principles. These two effects cause the air to be “pumped” away from the still air in the space behind the surface that is relatively perpendicular to the flow. Increased pressure behind the surface that is perpendicular to the flow results in this vortex shedding pumping action and repeating pumping action will continue the resulting drag.

The rearward facing surface(s) in the aft section as shown in Figures provides a surface for the flow to follow, thereby eliminating or significantly reducing this pumping and vortex shedding wave action. Consequently, a more laminar or homogeneous flow around the surface perpendicular to the flow is achieved. As the tail fairing provides a surface for the flow along, the pumping action and resulting wave is eliminated thereby resulting in reduced drag.

Because the tail fairing's surface(s) provide a surface for the flow to follow, the resulting lamina or homogeneous flow reduces drag. Conceptually, if the drag created by the mirror, mirror housing, forward- or rearward-viewing device is reduced, then it is possible to reduce the overall drag of the vehicle.

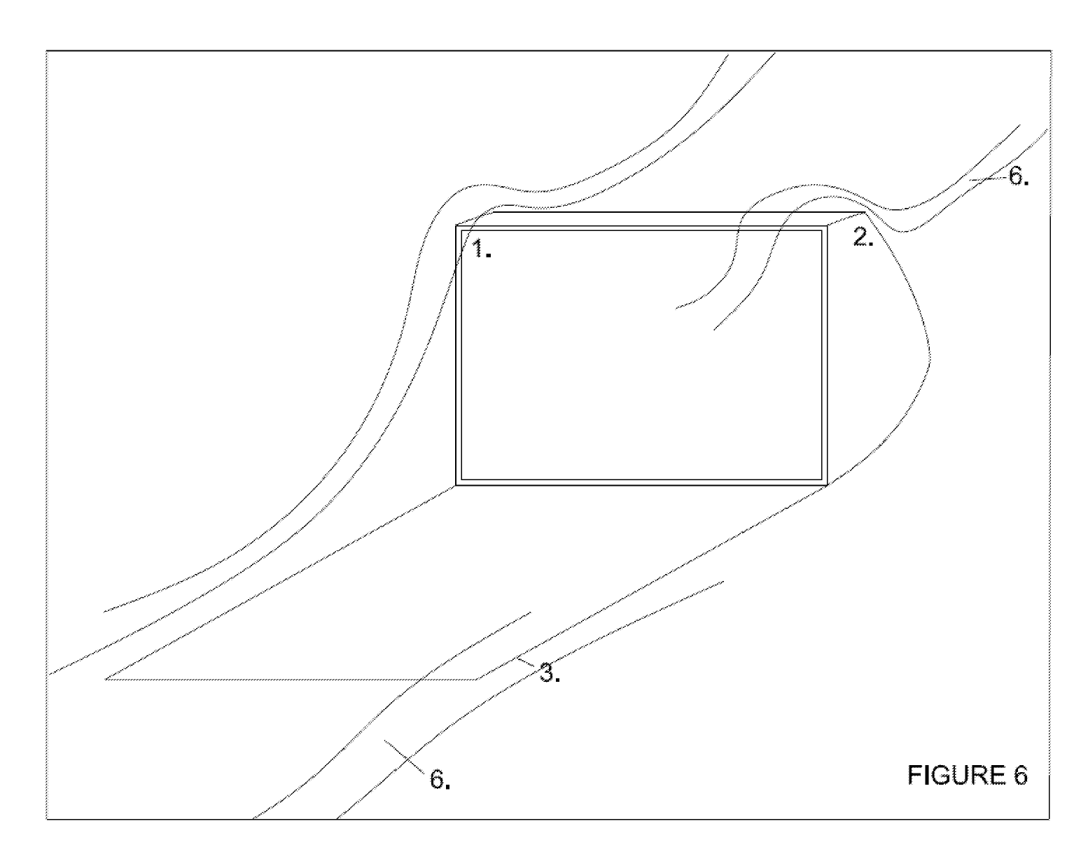

The mirror, mirror housing, rearward- or forward-viewing device's trailing device reduces the overall drag. Clearly, one other convenient method of reducing drag is to add a leading-edge fairing. Other methods, such as vortex generators to energize the boundary layer, introduce intrusiveness that reduces their effectiveness. The benefits of using a single surface include reducing the pumping action and resulting vortex shedding, minimal weight penalty, mechanical simplicity, and low cost. This configuration is depicted in FIG. 6.

In one embodiment of the invention, a closed housing reduces drag of the mirror, mirror housing, forward- or rearward-viewing device where the flow that is separated by the leading edge rejoins and thereby reduces the aerodynamic drag of a mirror or rearward-facing device.

In an alternative embodiment, the single surface provides a buffer for the pumping action of the aforementioned flow to press against and the resulting cushion creates a boundary layer that is effectively mimicking a closed housing by providing a shear layer that runs along a non-existent surface. This cushion provides a surface for the flow to push against reducing the pumping action and resulting drag.

All embodiments of the invention may be practiced on flight, ground or aquatic vehicles, and at all speeds, including hypersonic.

While the above embodiments deal with passive structures, it is envisioned that active structures that involve mechanised application of aerodynamic actuators, such as power opening and closing of vents, adjustments of wings and the like, may be deployed either alternatively or in combination with such passive structures.

Furthermore, while in embodiments the structures described herein may be made with materials such as plexi-glass that are passive and generally rigid, it is envisioned that materials may be available that are softer and more flexible than plexi-glass. Preferably, such a material provides high optical clarity so objects such as the mirror itself can be clearly seen through the material, but also provides flex in response to being pushed or hit so that it does not break in the event that it is jostled or bumped by another object.

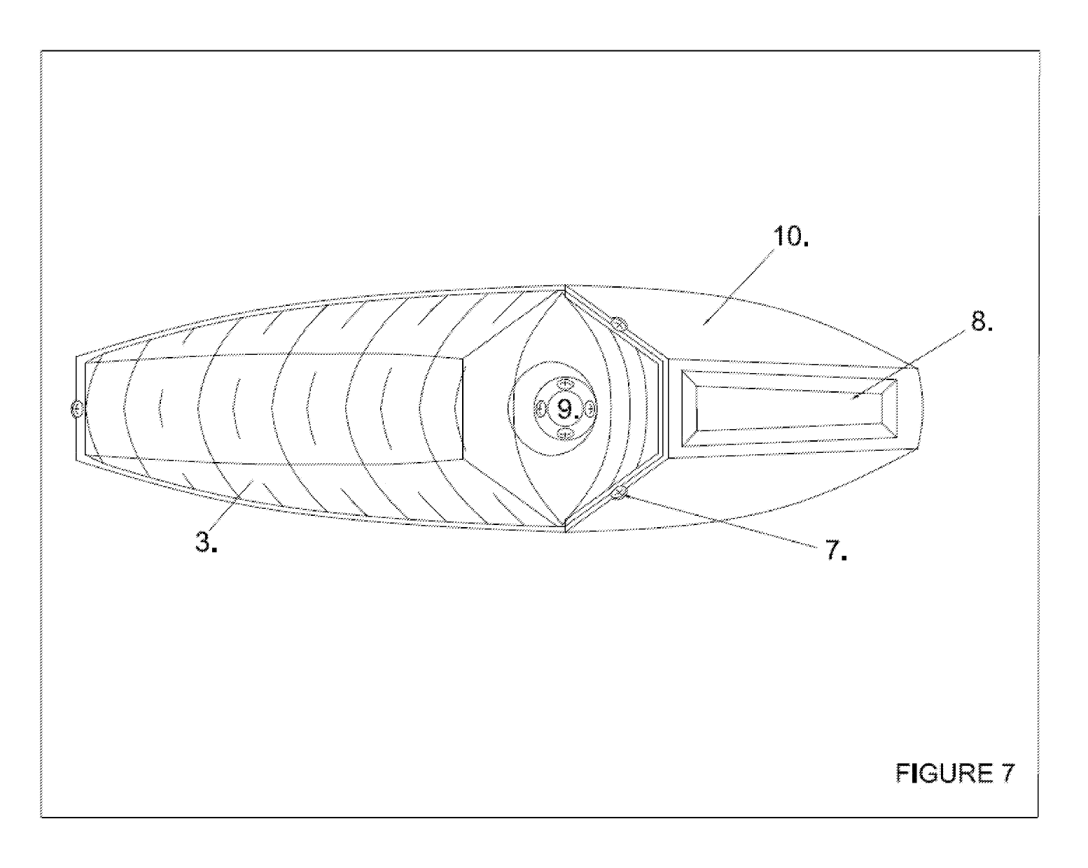

FIG. 7 is a front view of an alternative embodiment showing a side-mounted camera tail application in which a housing houses a rear-viewing camera and a marker light, the rear-viewing camera electronically communicating with a display screen (not shown) for displaying the objects within the field of view of the rear-viewing camera. While the driver within the vehicle may be able to view the camera through the aerodynamic lens cover as the driver is able to view the mirror in other embodiments, in this embodiment even if the camera lens itself is not viewable by the driver the camera's rearward field of view is able to capture at least the objects that a similarly-situated mirror would reflect to a driver's eyes.

Although embodiments have been described with reference to the drawings, variations may be made without departing from the purpose, spirit and scope as defined in the appended claims.

What is claimed is:

1. A method for reducing the drag of a vehicle having a rearward-facing mirror or rearward- or forward- viewing device by increasing the length such device's housing with a trailing edge consisting of a closed housing in clear material that forms an aerodynamic tail, thereby significantly reducing the aerodynamic drag of said devices.

2. An external mirror system for a vehicle comprising:
a mirror housing supporting a rearward-facing mirror having an exterior surface forming a leading edge forward of the mirror; and
a transparent enclosure aligned with and extending continuously rearward with respect to the mirror from the exterior surface of the mirror housing to a substantially-narrowed trailing edge, and
wherein the mirror is viewable through the transparent enclosure from within the vehicle.

3. An external mirror system for a vehicle comprising:
a mirror housing supporting a rearward-facing mirror having a continuous exterior surface forming a leading edge forward of the mirror and a substantially narrowed trailing edge rearward of the mirror, wherein at least a portion of the mirror housing is transparent in order to permit viewing the mirror from within the vehicle.
